(19) United States
(12) Patent Application Publication
(10) Pub. No.: US 2017/0130654 A1
(43) Pub. Date: May 11, 2017

(54) STARTING CIRCUIT FOR GENERATOR-STARTER WITH THREE TERMINALS AND STARTING METHOD

(71) Applicant: THALES, COURBEVOIE (FR)

(72) Inventor: Damien DEMUYNCK, CHATOU (FR)

(21) Appl. No.: 15/320,728

(22) PCT Filed: Jun. 26, 2015
(86) PCT No.: PCT/EP2015/064584

§ 371 Date: Dec. 20, 2016

(30) Foreign Application Priority Data
Jun. 27, 2014 (FR) 1401453

(51) Int. Cl. F02C 7/275; H02H 7/06; F02N 11/04

(52) U.S. Cl. CPC F02C 7/275; F02N 11/04; H02H 7/06; F02N 2200/043; F02N 2300/104; F05D 2220/76; F05D 2260/85

(57) ABSTRACT

A starting circuit for a generator-starter with three terminals comprises a positive power terminal, a negative power terminal, a positive starting terminal, an armature winding, a commutating winding, a series winding, the series winding, the armature winding and the commutating winding connected in series and a shunt winding. The generator-starter further comprises a voltage regulator having a first terminal and a second terminal, the first terminal connected to a positive terminal of the shunt winding and the second terminal connected to a positive power terminal, so that the shunt winding and the series winding are linked in parallel for a duration of a starting phase. A method for starting such a generator-starter is also provided.

The invention relates to a starting circuit for a generator-starter with three terminals. The generator-starter with three terminals is used as starter for starting turbojet engines, turboprop engines, turboshaft engines for aeronautical use and as main generators of electrical networks onboard airplanes, helicopters and drones. The present application refers to a generator-starter with three terminals mounted on a turbine. The invention relates also to a method for starting such a generator-starter.

The generator-starter with three terminals is an electrical machine which operates in starter mode to start the turbine, then in generator mode to supply the electrical power necessary to the onboard network or any other system requiring electrical power. Hereinbelow, interest is focused particularly on the starter mode. A starting phase can be defined by a phase during which the generator-starter with three terminals operates in starter mode. The start of the starting phase is initiated by the closure of the starting contactor. The end of the starting phase is reached when the turbine reaches the end-of-starting speed. The choice of the generator-starter with three terminals to be mounted on a given turbine is made notably by taking into account its starting capacity and as a function of the electrical power demanded by the onboard network.

The generator-starter with three terminals comprises a series winding which supplies the ampere-turns in starter mode when the series winding is powered by a direct current source. The series winding is not powered in generator mode.

A generator-starter has a break section, the torque of which is defined by the turbine manufacturer. In effect, if the torque developed by the generator-starter is too high, the break section acts as a mechanical fuse in order to protect the turbine.

During a starting phase, a generator-starter generates a given torque for a given maximum current intensity. For some applications, it has been noted that the margin between the torque of the break section and the torque developed by the generator-starter is insufficient, resulting in a breaking of the torque shaft of the generator-starter at the break section. In other words, when the initial torque of the generator-starter with three terminals during the starting phase is too high, the break section serves its purpose as mechanical fuse and breaks in order to protect the turbine.

Since the torque of the break section is defined by the manufacturer of the turbine, it cannot be increased without the agreement of the manufacturer.

In order to avoid the problem of breaking of the torque shaft, since the torque of the break section cannot be increased, it is the number of turns of the series winding which can be reduced, thus reducing the magnetic flux. The torque developed by the generator-starter is therefore reduced: this necessitates checking that the torque developed by the generator-starter exhibits sufficient margin relative to the resisting torque of the turbine in order to ensure that the starting time is acceptable. However, reducing the number of turns of the series winding of the generator-starter also means that a new generator-starter has to be designed.

The invention aims to mitigate all or some of the problems cited above by proposing a different connection at the starting circuit of the generator-starter with three terminals to allow for a reduction of the initial torque of the generator-starter with three terminals for a predetermined duration of the starting phase.

To this end, the subject of the invention is a generator-starter with three terminals comprising:

a positive power terminal,

a negative power terminal,

a positive starting terminal,

an armature winding, with a commutator,

positive brushes rubbing on the commutator of the armature winding,

negative brushes rubbing on the commutator of the armature winding,

a commutating winding having two terminals, a first terminal being connected to the negative brushes, a second terminal being connected to the power terminal,

a series winding having two terminals, a first terminal being connected to the starting terminal, a second terminal being connected to a point situated between the positive brushes and the power terminal, the series winding, the armature winding and the commutating winding being connected in series,

a shunt winding having two terminals, a first terminal being connected to a positive terminal, a second terminal being connected to a point situated between the negative brushes and the first terminal of the commutating winding, characterized in that it further comprises a voltage regulator having a first terminal and a second terminal,

and in that the first terminal is connected to the positive terminal of the shunt winding and the second terminal is connected to the positive power terminal.

Another subject of the invention is a method for starting such a generator-starter with three terminals, characterized in that it comprises a step of powering of the shunt winding throughout the duration of the starting phase. This powering is done by the connection of the positive terminal of the shunt winding accessible on the terminal block to the positive power terminal of the generator-starter with three terminals so that the shunt winding and the series winding are linked in parallel.

The invention will be better understood and other advantages will become apparent on reading the detailed description of an embodiment given by way of example, the description being illustrated by the attached drawing in which:

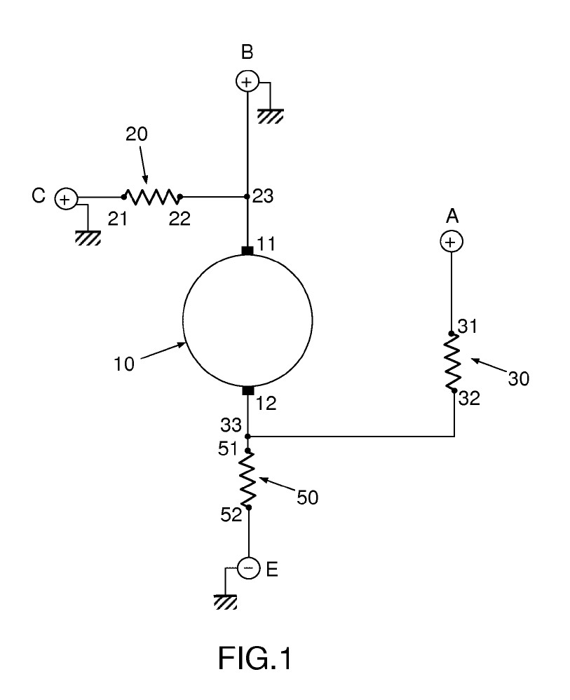

FIG. 1 represents a starting circuit of a generator-starter according to the prior art;

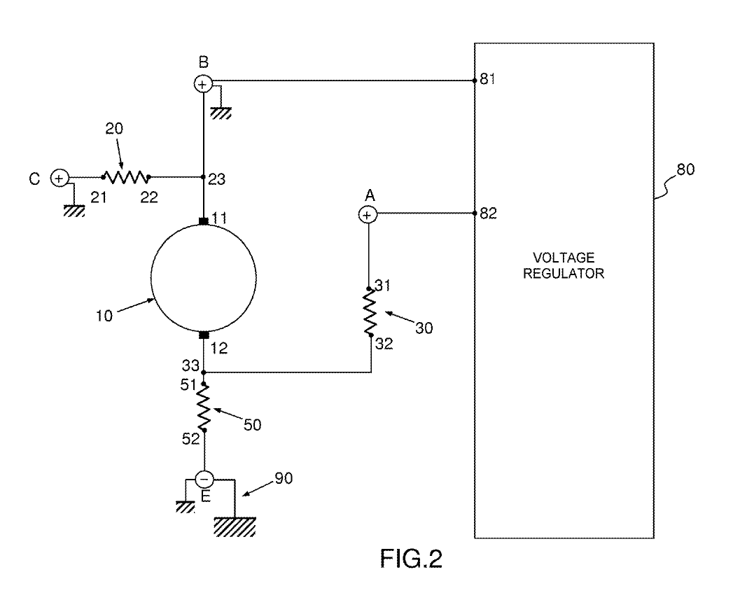

FIG. 2 represents a first variant of the starting circuit of a generator-starter according to the invention;

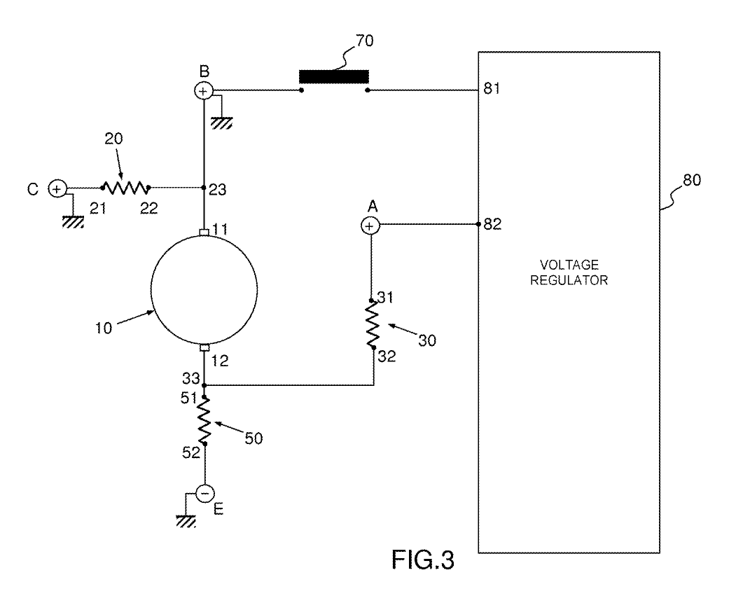

FIG. 3 represents a second variant of the starting circuit of a generator-starter according to the invention;

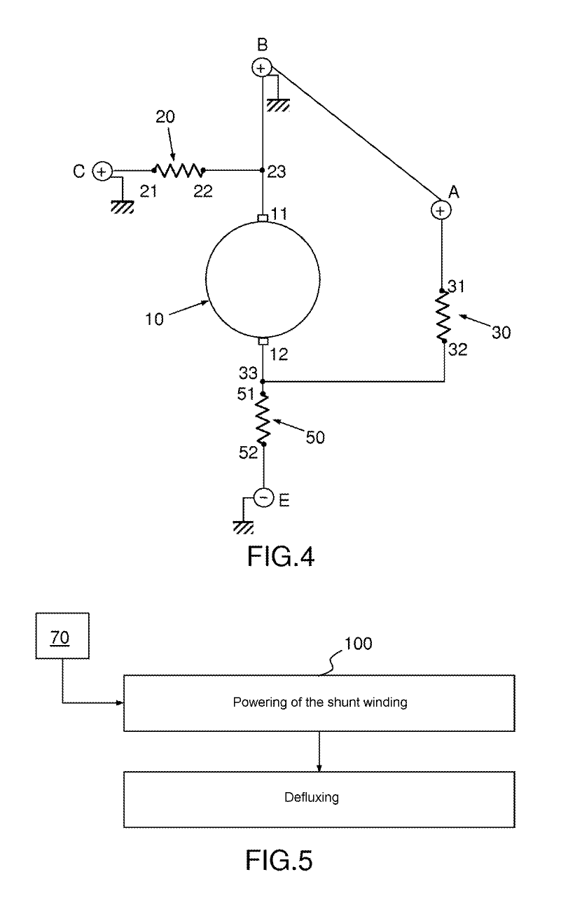

FIG. 4 represents a third variant of the starting circuit of a generator-starter which makes it possible to run tests;

FIG. 5 represents a variant of a method for starting a generator-starter according to the invention.

In the interests of clarity, the same elements will bear the same references in the different figures. In FIGS. 1, 2, 3 and 4, the second terminal of the shunt winding 30 is connected at a point situated between the negative brushes and the terminal of the winding of the commutation poles connected to the negative brushes.

FIG. 1 represents a starting circuit of a generator-starter according to the prior art. The generator-starter with three terminals comprises a positive power terminal B, a negative power terminal E, a positive starting terminal C. It further comprises an armature winding 10 with a commutator, positive brushes 11 rubbing on the commutator of the armature winding 10, negative brushes 12 rubbing on the commutator of the armature winding 10. The generator-starter with three terminals comprises a commutating winding 50 having two terminals 51, 52, a first terminal 51 being connected to the negative brushes 12, a second terminal 52 being connected to the power terminal E. It comprises a series winding 20 having two terminals 21, 22, a first terminal 21 being connected to the starting terminal C, a second terminal 22 being connected to a point 23 situated between the positive brushes 11 and the power terminal B. The series winding 20, the armature winding 10 and the commutating winding 50 are connected in series. The generator-starter with three terminals comprises a shunt winding 30 having two terminals 31, 32, a first terminal 31 being connected to a positive terminal A, a second terminal 32 being connected to a point 33 situated between the negative brushes 12 and the first terminal 51 of the commutating winding 50.

For some generator-starters with three terminals, the terminal 32 of the shunt winding 30 is connected to the power terminal E. The shunt winding 30 is not powered in starter mode.

The commutating winding 50 makes it possible to limit, at the brushes 11 and 12, the appearance of sparks which could damage the commutator of the generator-starter. The commutating winding 50 is connected in series with the armature winding 10. The winding 50 may include, in addition to the commutating winding, a compensation winding for certain generator-starters with three terminals.

The configuration represented in FIG. 1 will be called the series starting configuration.

FIG. 2 represents a first variant of the circuit diagram of the starting circuit of a generator-starter according to the invention. The starting circuit according to the invention represented in FIG. 2 comprises the same elements as the starting circuit represented in FIG. 1. According to the invention, the generator-starter further comprises a voltage regulator 80 having a first terminal 82 and a second terminal 81. The first terminal 82 is connected to the positive terminal A of the shunt winding 30 and the second terminal 81 is connected to the positive power terminal B. Thus, the shunt winding 30 and the series winding 20 are linked in parallel throughout the duration of the starting phase. The configuration represented in FIG. 2 will be called the series+shunt configuration.

FIG. 3 represents a second variant of the starting circuit of a generator-starter according to the invention. The starting circuit represented in FIG. 3 comprises the same elements as the starting circuit represented in FIG. 2. In addition, the generator with three terminals comprises a time-delay contactor 70 inserted between the terminal B and the terminal 81, so that the shunt winding 30 and the series winding 20 are linked in parallel for a predetermined duration of a starting phase. The time-delay contactor 70 ensures the powering of the shunt winding 30 for a duration that is sufficient to reduce the initial torque of the generator-starter in starter mode. This duration is of the order of 500 ms, but can vary according to the generator-starters and turbines implemented. Then, the time-delay contactor 70 is opened. The generator-starter then operates as a series starter, the starting circuit of which is represented in FIG. 1.

The voltage regulator 80 associated with a generator-starter with three terminals makes it possible to ensure, if necessary, for a predefined balancing voltage, a defluxing phase, also called field weakening phase. The balancing voltage corresponds to an image of the main current through the commutating winding 50 and a negative airplane cable 90. The defluxing phase makes it possible to operate at a constant power after the turbine is switched on.

FIG. 4 represents another variant of the starting circuit of a generator-starter according to the invention, a simplified variant for performing tests. Experimental tests performed according to FIG. 4 with a 0.4 ohm resistance between the terminals B and A in series configuration and in series+shunt configuration show that, for different intensity values during the starting phase, the initial torque is significantly lower for the series+shunt configuration than for the series configuration. In other words, the starting circuit according to the invention makes it possible to reduce the initial torque of the generator-starter with three terminals during the starting phase. For example, for an intensity of 920 A, the series+shunt configuration makes it possible to obtain an initial torque of 51 Nm which is 14% lower than the torque of the series configuration of 58 Nm. For an intensity of 650 A, the reduction of the initial torque with the series+shunt configuration compared to the series configuration is 28% (torque of 30 Nm for the series+shunt configuration and 42 Nm for the series configuration).

More specifically, during the starting phase and in series+shunt configuration, it has been observed that the excitation current in the shunt winding 30 is negative. Thus, the ampere-turns of the shunt winding 30 are subtractive. This is a transient coupling phenomenon between the series winding 20 and the shunt winding 30 of the generator-starter with three terminals.

Thus, the starting circuit of the generator-starter with three terminals according to the invention makes it possible to reduce the initial torque of the generator-starter with three terminals throughout the duration of the starting phase, or for a predetermined duration of the starting phase. The margin between the torque of the break section and the torque developed by the generator-starter is sufficient. With the reduction of the initial torque, the turbine is less stressed and there is no starting time penalty.

The method for starting the generator-starter with three terminals B, E, C is capable of developing a predefined torque during the starting phase to start, by means of an initial torque, a turbine from a zero speed to a so-called end-of-starting speed. In other words, at the start of the starting phase the turbine has a zero speed and the objective of the generator-starter is to drive it, therefore to switch it from a zero speed to a non-zero speed. At this start of starting phase, the excitation current is maximum. The problem which arises is the presence of a high initial torque at the maximum current right at the start of the starting phase. The method according to the invention makes it possible to reduce the initial torque while allowing the turbine to switch from a zero speed to the desired end-of-starting speed. As explained previously, the margin between the torque of the break section of the turbine and the initial torque developed by the generator-starter then becomes sufficient by virtue of the method according to the invention.

FIG. 5 represents a variant of a method for starting a generator-starter according to the invention. The method for starting a generator-starter according to the invention comprises a step 100 of powering of the shunt winding 30 throughout the duration of the starting phase. In the case where the generator-starter comprises a time-delay contactor 70, the step 100 of powering of the shunt winding 30 can be carried out for a predetermined duration of the starting phase. The method can comprise a defluxing phase ensured by the voltage regulator 80.

1. A method for starting a generator-starter with three terminals capable of developing a predefined torque during a starting phase for starting, by means of an initial torque, a turbine from a zero speed to a so-called end-of-starting speed, comprising:
a positive power terminal
a negative power terminal
a positive starting terminal
an armature winding, with a commutator
positive brushes rubbing on the commutator of the armature winding,
negative brushes rubbing on the commutator of the armature winding,
a commutating winding having two terminals, a first terminal being connected to the negative brushes, a second terminal being connected to the power terminal,
a series winding having two terminals, a first terminal being connected to the starting terminal, a second terminal being connected to a point situated between the positive brushes and the power terminal, the series winding, the armature winding and the commutating winding being connected in series,
a shunt winding having two terminals, a first terminal being connected to a positive terminal, a second terminal being connected to a point situated between the negative brushes and the first terminal of the commutating winding,
a voltage regulator having a first terminal and a second terminal the first terminal being connected to the positive terminal of the shunt winding and the second terminal being connected to the positive power terminal,
comprising a step of powering of the shunt winding throughout the duration of the starting phase, so as to reduce the initial torque.

2. The method for starting a generator-starter with three terminals as claimed in claim 1, comprising a step of powering of the shunt winding for a predetermined duration of the starting phase.

3. The starting method as claimed in claim 2, comprising a defluxing phase ensured by the voltage regulator.

4. A generator-starter with three terminals, capable of implementing a method as claimed in claim 1, comprising:
a positive power terminal
a negative power terminal
a positive starting terminal
an armature winding, with a commutator
positive brushes rubbing on the commutator of the armature winding,
negative brushes rubbing on the commutator of the armature winding,
a commutating winding having two terminals, a first terminal being connected to the negative brushes, a second terminal being connected to the power terminal,
a series winding having two terminals, a first terminal being connected to the starting terminal, a second terminal being connected to a point situated between the positive brushes and the power terminal, the series winding, the armature winding and the commutating winding being connected in series,
a shunt winding having two terminals, a first terminal being connected to a positive terminal, a second terminal being connected to a point situated between the negative brushes and the first terminal of the commutating winding,
further comprising a voltage regulator having a first terminal and a second terminal,
wherein the first terminal is connected to the positive terminal of the shunt winding and the second terminal is connected to the positive power terminal.

5. The generator-starter with three terminals as claimed in claim 4, further comprising a time-delay contactor between the positive power terminal of the generator-starter and the second terminal of the voltage regulator intended to link the shunt winding and the series winding in parallel for a predetermined duration of a starting phase.
